(19) United States
(12) Patent Application Publication
(10) Pub. No.: US 2025/0190829 A1
(43) Pub. Date: Jun. 12, 2025

(54) QUANTUM CIRCUIT SIMULATION METHOD AND INFORMATION PROCESSING APPARATUS

(71) Applicant: Fujitsu Limited, Kawasaki-shi (JP)

(72) Inventor: Takanori NAKAO, Kawasaki (JP)

(73) Assignee: Fujitsu Limited, Kawasaki-shi (JP)

(21) Appl. No.: 18/959,925

(22) Filed: Nov. 26, 2024

(30) Foreign Application Priority Data
Dec. 12, 2023 (JP) 2023-209570

(51) Int. Cl. G06N 10/20

(52) U.S. Cl. CPC G06N 10/20

(57) ABSTRACT

A memory stores quantum circuit data defining a quantum circuit that varies with the value of a parameter. For a common part where the types and sequence of one or more quantum gates are common in a first quantum circuit generated with a first value input into the parameter and a second quantum circuit generated with a second value input into the parameter, a processor generates tensor data representing the computation result of the common part using tensor data representing the quantum operation performed by the one or more quantum gates included in the common part. The processor computes the computation result of the first quantum circuit and the computation result of the second quantum circuit using the generated tensor data.

### CROSS-REFERENCE TO RELATED APPLICATION

This application is based upon and claims the benefit of priority of the prior Japanese Patent Application No. 2023-209570, filed on Dec. 12, 2023, the entire contents of which are incorporated herein by reference.

### FIELD

The embodiments discussed herein relate to a quantum circuit simulation method and an information processing apparatus.

### BACKGROUND

A quantum computation may sometimes be described using a computational model called a quantum circuit, which is a combination of a plurality of quantum gates. A user may execute such quantum circuits on a quantum gate-type quantum computer. Alternatively, instead of using the quantum computer, the user may use a classical computer to simulate the computation results of the quantum circuits. Quantum circuit simulation using classical computers may be performed for the development of quantum computing algorithms and application software.

For example, there has been proposed a quantum circuit simulation method in which a quantum computation process represented by a quantum circuit is expressed as a tensor network, and the result of the quantum computation process is computed on a classical computer through the contraction of the tensor network. In this proposed method, the contraction involves multiplication between an n-qubit state tensor and a quantum gate tensor.

See, for example, Japanese Laid-open Patent Publication No. 2022-3501.

### SUMMARY

According to one aspect, there is provided a non-transitory computer-readable storage medium storing a computer program that causes a computer to perform a process including: obtaining quantum circuit data defining a quantum circuit that varies with a value of a parameter; generating, using first tensor data for a common part of a first quantum circuit and a second quantum circuit, second tensor data, the first tensor data representing a quantum operation performed by one or more quantum gates included in the common part, the second tensor data representing a computation result of the common part, the first quantum circuit being generated with a first value input into the parameter, the second quantum circuit being generated with a second value input into the parameter, the common part being where types and sequence of the one or more quantum gates are common; and computing a computation result of the first quantum circuit and a computation result of the second quantum circuit using the second tensor data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for describing an information processing apparatus according to a first embodiment;

FIG. 2 illustrates an example of the hardware configuration of an information processing apparatus according to a second embodiment;

FIG. 3 illustrates an example of computing a ground-state energy using a quantum circuit;

FIG. 4 illustrates an example of an ansatz circuit with parameters;

FIG. 5 illustrates an example of the structure of a matrix product state;

FIG. 6 illustrates an example of computing a quantum circuit using a matrix product state;

FIG. 7 illustrates a first example of contraction and singular value decomposition;

FIG. 8 illustrates a second example of contraction and singular value decomposition;

FIG. 9 illustrates an example of saving reusable matrix product states;

FIG. 10 illustrates an example of saving reusable matrix product operators;

FIG. 11 illustrates an example of reusing matrix product states and matrix product operators;

FIG. 12 illustrates an example of the functions of the information processing apparatus according to the second embodiment;

FIG. 13 illustrates an example of an energy search table; and

FIG. 14 is a flowchart of an example procedure for quantum circuit simulation.

### BRIEF DESCRIPTION OF DRAWINGS

A computer may generate a plurality of quantum circuits with different values of parameters and compute the computation result of each of the plurality of quantum circuits. For example, a variational quantum eigensolver (VQE) generates quantum circuits, each including an ansatz circuit corresponding to the wave function of the Schrödinger equation and a Hamiltonian circuit corresponding to the Hamiltonian of the Schrödinger equation. The VQE then computes expected values of energy using the quantum circuits to search for a wave function that minimizes the energy. In this case, the ansatz circuit varies with a trial wave function.

Note, however, that iterating the quantum circuit simulation while changing the values of the parameters imposes a high computational load on the computer.

Hereinafter, embodiments will be described with reference to the accompanying drawings.

### First Embodiment

A first embodiment will now be described.

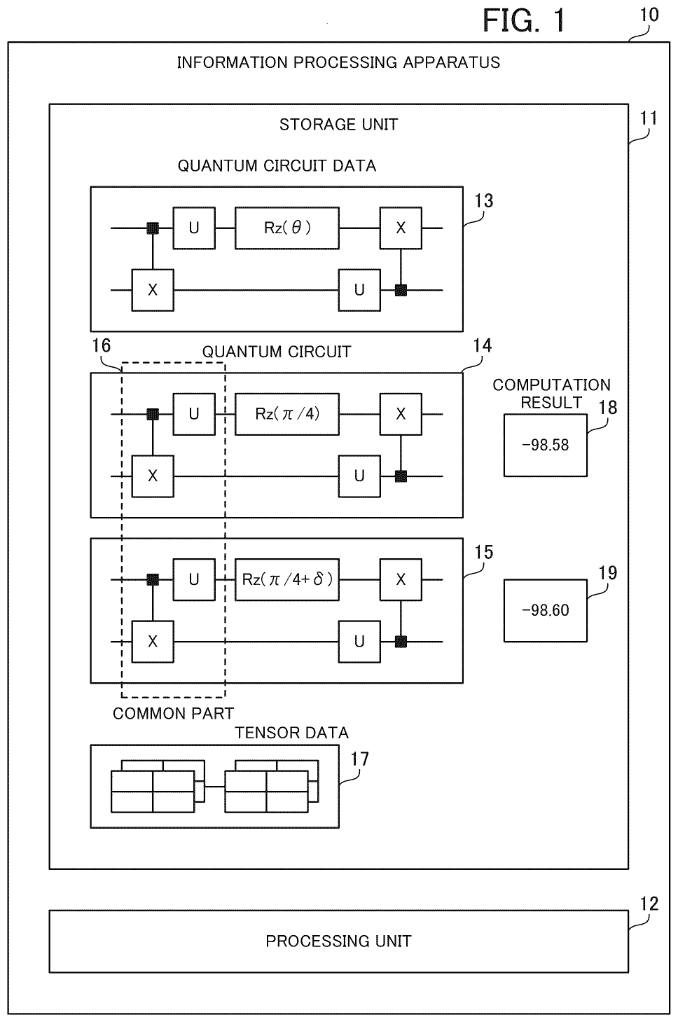

FIG. 1 is a view for describing an information processing apparatus according to the first embodiment.

The information processing apparatus 10 performs quantum circuit simulation to simulate the computation results of quantum circuits. There is no need to use a quantum computer for the quantum circuit simulation. The information processing apparatus 10 may be a von Neumann's classical computer. The information processing apparatus 10 may be a client device or a server device. Furthermore, the information processing apparatus 10 may be referred to as a computer or a quantum circuit simulation device.

The information processing apparatus 10 includes a storage unit 11 and a processing unit 12. The storage unit 11 may be a volatile semiconductor memory, such as random access memory (RAM). Alternatively, the storage unit 11 may be a non-volatile storage device, such as a hard disk drive (HDD) or flash memory.

The processing unit 12 is, for example, a processor such as a central processing unit (CPU), a graphics processing unit (GPU), or a digital signal processor (DSP). Note that the processing unit 12 may include an application specific integrated circuit (ASIC), a field programmable gate array (FPGA), or another electronic circuit. For example, the processor runs programs stored in a memory such as RAM (which may be the storage unit 11). The processor may be referred to as processor circuitry. The information processing apparatus 10 may be provided with a plurality of processors. A set of these processors may be referred to as a multiprocessor or simply a “processor.” Different processors may perform different ones of a plurality of processes performed by the information processing apparatus 10.

The storage unit 11 stores quantum circuit data 13. For example, the quantum circuit data 13 is generated by a user. The information processing apparatus 10 may accept the quantum circuit data 13 input by the user or receive the quantum circuit data 13 from another information processing apparatus. The quantum circuit data 13 defines a quantum circuit that varies with the value of a parameter. When a value is input into the parameter, a quantum circuit is generated from the quantum circuit data 13.

A quantum circuit is a quantum computational model that describes a procedure for a quantum computation using a combination of a plurality of quantum gates. A quantum circuit diagram is such that a plurality of quantum gates arranged horizontally are executed in order from left to right. At the leftmost end in the quantum circuit diagram, one or more qubits are individually initialized. At the rightmost end in the quantum circuit diagram, the states of the one or more qubits are individually measured. Each quantum gate may be a single-input quantum gate, such as a unitary rotation gate, or a multi-input quantum gate, such as a controlled-NOT gate.

The quantum circuit data 13 may include a variable quantum gate that performs a quantum operation based on the value of the parameter. The variable quantum gate may be a variable rotation gate with a parameter indicating a rotation angle. In addition to the variable quantum gate, the quantum circuit data 13 may include a fixed quantum gate that performs a fixed quantum operation, which does not depend on the value of any parameter. In this connection, a parameter used does not need to be the one that affects the operation of a quantum gate but may be the one that affects the overall structure of the quantum circuit such as the sequence of a plurality of quantum gates.

The quantum circuit data 13 may be used for parameter search to find an optimal value of a parameter. For example, the information processing apparatus 10 generates a plurality of quantum circuits by changing the value of the parameter, and searches for a value of the parameter that optimizes the computation results of the quantum circuits.

A VQE is an example of an algorithm used for such parameter search. Quantum circuits the VQE uses each include an ansatz circuit corresponding to the wave function of the Schrödinger equation and a Hamiltonian circuit corresponding to the Hamiltonian of the Schrödinger equation. The Hamiltonian circuit is determined on the basis of the structure of an analysis target such as a molecular structure. The ansatz circuit is determined on the basis of a trial wave function and depends on values of parameters. For example, the rotation angles of rotation gates in the ansatz circuit vary with a trial wave function. The VQE searches for a wave function that minimizes the energy computed using the quantum circuits.

The processing unit 12 computes the computation result of each of the plurality of quantum circuits generated from the quantum circuit data 13 through quantum circuit simulation. More specifically, the processing unit 12 generates a quantum circuit 14 (first quantum circuit) from the quantum circuit data 13 by inputting a first value into the parameter. In addition, the processing unit 12 generates a quantum circuit 15 (second quantum circuit) from the quantum circuit data 13 by inputting a second value, which is different from the first value, into the parameter.

The processing unit 12 performs a quantum computation based on the quantum circuit 14 through the quantum circuit simulation to thereby compute a computation result 18. In addition, the processing unit 12 performs a quantum computation based on the quantum circuit 15 through the quantum circuit simulation to thereby obtain a computation result 19. Each of the computation results 18 and 19 represents, for example, the energy of the analysis target such as a molecular energy. For example, the computation result 18 represents an energy corresponding to a certain wave function, whereas the computation result 19 represents an energy corresponding to another wave function.

In the quantum circuit simulation, a quantum computation is represented as a transformation of tensor data with complex numbers as its elements. The tensor data may be a first-order tensor, i.e., a vector, a second-order tensor, i.e., a matrix, or a third-order or higher-order tensor. The order (first-order, second-order, third-order, etc.) of a tensor may sometimes be considered as the number of dimensions (one-dimensional, two-dimensional, three-dimensional, etc.) of the tensor. Furthermore, the tensor data may be a tensor network, in which a large tensor is decomposed into the product of a plurality of smaller tensors.

The quantum circuit simulation in the first embodiment may use a state vector method or may use a tensor network method. In general, in the state vector method, the quantum state of a quantum circuit with n qubits is represented as a 2ⁿ-dimensional state vector, and a quantum operation on this quantum state is represented as a (2ⁿ×2ⁿ)-dimensional matrix.

The processing unit 12 is able to compute the computation result of the quantum circuit by sequentially multiplying the initial value of the state vector by the plurality of matrices corresponding to the plurality of quantum gates. In this connection, before multiplying the state vector, the processing unit 12 may first compute the product of two matrices corresponding to two adjacent quantum gates to thereby combine the two quantum gates. That is, the processing unit 12 is able to perform multiplications between the plurality of matrices corresponding to the plurality of quantum gates in any order.

In the tensor network method, on the other hand, the initial states of qubits and the quantum operations of quantum gates are each represented by a tensor whose order equals the number of connections. In general, an m-input, m-output quantum gate is represented as a tensor of order 2m. The processing unit 12 combines two connected tensors through a contraction that computes the product of the two tensors. The contraction may result in a tensor with a different order or number of dimensions. With such tensors, the processing unit 12 represents the application of a quantum gate to qubits and a combination of quantum gates.

The processing unit 12 is able to compute the computation result of the quantum circuit by iteratively performing a tensor network contraction. At this time, the processing unit 12 may perform the contraction in the forward direction from the beginning to the end of the quantum circuit. In this connection, the processing unit 12 may perform the contraction of any tensors first within the tensor network.

A matrix product state (MPS) may be used as a tensor network. The MPS is a tensor network in which a plurality of tensors corresponding to a plurality of qubits are connected in series. The processing unit 12 represents the initial states of a plurality of qubits using an MPS and sequentially combines the tensors of the quantum gates with this MPS. When a tensor representing a multi-input quantum gate is contracted, the resulting tensor may be in a form other than the MPS form. In such a case, the processing unit 12 may use, for example, singular value decomposition (SVD) to decompose the resulting tensor into the MPS form.

By the way, the quantum circuits 14 and 15, which are generated from the quantum circuit data 13, may include a common part 16 where the types and sequence of quantum gates are common (for example, the same types and the same sequence). The common part 16 may be a quantum circuit in a section ranging from the beginning to before a variable quantum gate of each quantum circuit 14 and 15, or may be a quantum circuit in a section ranging from after the variable quantum gate to the end of each quantum circuit 14 and 15. In the case where the quantum circuits 14 and 15 include the common part 16, the processing unit 12 is able to reduce the computation time to compute the computation results 18 and 19.

The processing unit 12 generates tensor data 17 that represents the computation result of the common part 16, using tensor data that represents the quantum operations performed by the quantum gates included in the common part 16. The tensor data 17 may be considered as representing an intermediate state that is common to the quantum circuits 14 and 15 in computing the computation results 18 and 19.

The tensor data 17 may be a state vector that represents a quantum state obtained at the end of the common part 16. This state vector is obtained, for example, by multiplying the initial value of the state vector by the matrices corresponding to the quantum gates included in the common part 16. Alternatively, the tensor data 17 may be a matrix that represents a composite quantum gate that is a combination of the two or more quantum gates included in the common part 16. This matrix is obtained by, for example, sequentially multiplying the two or more matrices corresponding to the two or more quantum gates included in the common part 16.

Yet alternatively, the tensor data 17 may be a tensor or tensor network that represents the result of contracting tensors representing the quantum gates included in the common part 16 with a tensor representing the initial states of the qubits. Such a tensor network may be an MPS.

Still yet alternatively, the tensor data 17 may be a tensor or tensor network that represents the result of contracting the two or more tensors corresponding to the two or more quantum gates included in the common part 16. Such a tensor network may be a matrix product operator (MPO). Like the MPS, the MPO is a tensor network in which a plurality of tensors corresponding to a plurality of qubits are connected in series. However, unlike the MPS, in the MPO, a tensor representing the initial states of the qubits is not combined, and therefore each tensor has legs that are able to connect to other tensors located not only at the end side of a quantum circuit but also at the beginning side of the quantum circuit.

The processing unit 12 saves the tensor data 17 generated for the common part 16. Using the tensor data 17, the processing unit 12 computes the computation result 18 of the quantum circuit 14 and the computation result 19 of the quantum circuit 15. For example, the processing unit 12 computes the computation result 18 by performing the computation of the differential part including the variable quantum gate, into which the first value is already input, subsequent to the tensor data 17. Similarly, the processing unit 12 computes the computation result 19 by performing the computation of the differential part including the variable quantum gate, into which the second value is already input, subsequent to the tensor data 17.

In this connection, the processing unit 12 may generate the tensor data 17 for the common part 16 before computing the quantum circuits 14 and 15. Alternatively, the processing unit 12 may generate and save the tensor data 17 as an intermediate state during the process of computing the computation result 18 of the quantum circuit 14. Yet alternatively, the processing unit 12 may generate and save the tensor data 17 during a process of computing a quantum circuit other than the quantum circuits 14 and 15. In addition, the processing unit 12 may use both tensor data representing the computation result of the common part located before the variable quantum gate and tensor data representing the computation result of a common part located after the variable quantum gate, in order to compute the computation result 19.

The processing unit 12 outputs the obtained computation results 18 and 19. The processing unit 12 may store the computation results 18 and 19 in a non-volatile storage device, display them on a display device, or transmit them to another information processing apparatus. Similarly, the processing unit 12 may output the tensor data 17. The processing unit 12 may store the tensor data 17 in a non-volatile storage device, display it on a display device, or transmit it to another information processing apparatus.

As described above, the information processing apparatus 10 in the first embodiment obtains the quantum circuit data 13 defining a quantum circuit that varies with the value of a parameter. The information processing apparatus 10 generates the tensor data 17 for the common part 16 of the quantum circuit 14 generated with the first value input into the parameter and the quantum circuit 15 generated with the second value input into the parameter. The tensor data 17 represents the computation result of the common part 16 and is generated using tensor data representing the quantum operations performed by the quantum gates included in the common part 16. The information processing apparatus 10 computes the computation results 18 and 19 of the quantum circuits 14 and 15 using the tensor data 17.

In the manner described above, the information processing apparatus 10 is able to reuse the computation result of the common part 16 and thus eliminate the redundant computation of the common part 16, compared to computing the quantum circuits 14 and 15 independently. This reduces the computation time of the quantum circuit simulation. In addition, a plurality of quantum circuits generated from the quantum circuit data 13 with the parameter may include a common part that does not depend on the value of the parameter. Thus, the computational load of the parameter search for optimizing the computation results of the quantum circuits is reduced, and the search time is also reduced.

In addition, the tensor data 17 may be generated during a computation process of transforming tensor data in the forward direction from the beginning to the end of the quantum circuit 14 or in the backward direction from the end to the beginning of the quantum circuit 14. The computation result 18 may be obtained as a result of completing this computation process. This approach makes it possible to efficiently generate the tensor data 17 to be reused.

In addition, the quantum circuit data 13 may include a variable quantum gate that performs a different quantum operation depending on the value of a parameter. The common part 16 may be a section of the quantum circuit 14 located either before or after the variable quantum gate. Therefore, the tensor data 17 is generated efficiently during the process of computing the computation result 18, and then the tensor data 17 is efficiently reused in computing the computation result 19.

Furthermore, the common part 16 may include a first common part including the beginning of the quantum circuit 14 and a second common part including the end of the quantum circuit 14. The tensor data 17 may include tensor data representing the computation result of the first common part and tensor data representing the computation result of the second common part. This increases the extent of common parts whose computation results are reusable, which further streamlines the computation of the quantum circuit 15.

The tensor data 17 may represent a tensor network in which a plurality of tensors corresponding to a plurality of qubits are connected in series. This reduces the order and size of each tensor and thus streamlines the quantum circuit simulation of the quantum circuits 14 and 15.

The computation result 18 may represent a first energy corresponding to the first value of the parameter, and the computation result 19 may represent a second energy corresponding to the second value of the parameter. The information processing apparatus 10 may search for a value of the parameter that minimizes the computed energy on the basis of the first and second energies. This streamlines the parameter search using the quantum circuit data 13.

### Second Embodiment

A second embodiment will now be described.

The information processing apparatus 100 of the second embodiment executes a VQE for quantum circuit simulation. For example, the information processing apparatus 100 is used in quantum chemistry calculation to compute the ground-state energy of a molecule and the electronic state that yields this ground-state energy. The information processing apparatus 100 may be a client device or a server device. The information processing apparatus 100 may also be referred to as a computer or a quantum circuit simulation device. The information processing apparatus 100 corresponds to the information processing apparatus 10 of the first embodiment.

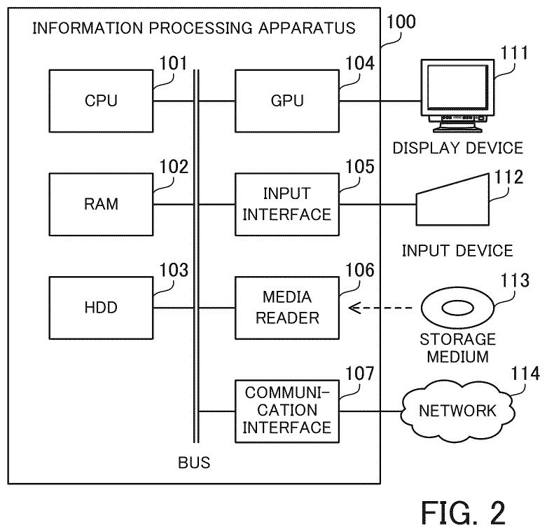

FIG. 2 illustrates an example of the hardware configuration of the information processing apparatus according to the second embodiment.

The information processing apparatus 100 includes a CPU 101, a RAM 102, an HDD 103, a GPU 104, an input interface 105, a media reader 106, and a communication interface 107, which are connected to a bus. The CPU 101 corresponds to the processing unit 12 of the first embodiment. The RAM 102 or HDD 103 corresponds to the storage unit 11 of the first embodiment.

The CPU 101 is a processor that executes program commands. The CPU 101 loads programs and data from the HDD 103 to the RAM 102 and runs the programs. The information processing apparatus 100 may be provided with a plurality of processors.

The RAM 102 is a volatile semiconductor memory that temporarily stores programs being run by the CPU 101, and data being used by the CPU 101 in processing. The information processing apparatus 100 may be provided with a different type of volatile memory than RAM.

The HDD 103 is a non-volatile storage device that stores software programs such as an operating system (OS), middleware, and application software, and data. The information processing apparatus 100 may be provided with another type of non-volatile storage device such as flash memory or a solid state drive (SSD).

The GPU 104 performs image processing in collaboration with the CPU 101 and outputs images to a display device 111 connected to the information processing apparatus 100. Examples of the display device 111 include a cathode ray tube (CRT) display, a liquid crystal display, organic electro-luminescence (EL) display, and an a projector. Another type of output device such as a printer may be connected to the information processing apparatus 100.

The GPU 104 may be used as a general-purpose computing on graphics processing unit (GPGPU). The GPU 104 is able to run programs in accordance with commands from the CPU 101. The information processing apparatus 100 may be provided with a volatile semiconductor memory other than the RAM 102 as a GPU memory.

The input interface 105 receives an input signal from an input device 112 connected to the information processing apparatus 100. Examples of the input device 112 include a mouse, a touch panel, and a keyboard. A plurality of input devices may be connected to the information processing apparatus 100.

The media reader 106 is a reading device that reads programs and data from a storage medium 113. Examples of the storage medium 113 include a magnetic disk, an optical disc, and a semiconductor memory. Magnetic disks include flexible disks (FDs) and HDDs. Optical discs include compact discs (CDs) and digital versatile discs (DVDs). The media reader 106 copies the programs and data from the storage medium 113 to another storage medium such as the RAM 102 or the HDD 103. The read programs may be run by the CPU 101.

The storage medium 113 may be a portable storage medium. The storage medium 113 may be used to distribute the programs and data. The storage medium 113 and HDD 103 may be referred to as computer-readable storage media.

The communication interface 107 communicates with other information processing apparatuses over a network 114. The communication interface 107 may be a wired communication interface that is connected to a wired communication device such as a switch or a router, or may be a wireless communication interface that is connected to a wireless communication device such as a base station or an access point.

The following describes the VQE.

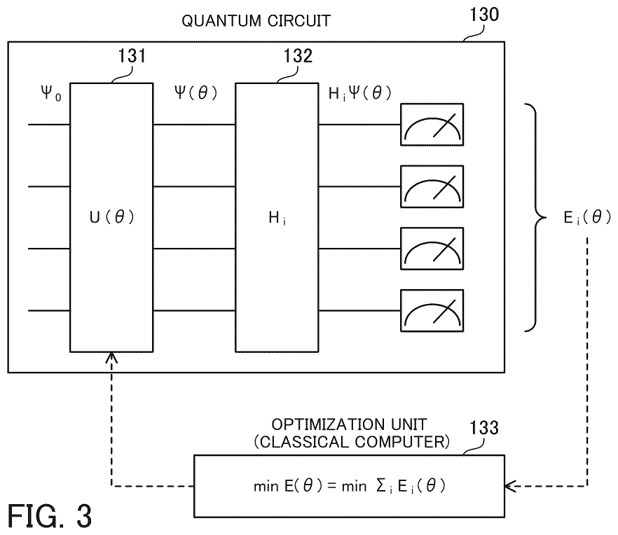

FIG. 3 illustrates an example of computing a ground-state energy using a quantum circuit.

The VQE is designed to find the ground-state energy and a wave function according to the Schrödinger equation. The ground-state energy is the energy of an analysis target in its stable state and has the lowest value among various energies corresponding to different wave functions. In the case where the analysis target is a molecule, the wave function describes the position of an electron included in the molecule. The energy of the molecule becomes lower as the electron is in an inner orbital around the nucleus.

The VQE computes an energy corresponding to a certain wave function using a quantum circuit 130. The VQE causes an optimization unit 133 to iteratively compute the energy while changing trial wave functions, so as to minimize the energy computed from the quantum circuit 130. The Schrödinger equation takes the form: HΨ(θ)=EΨ(θ), where H denotes Hamiltonian, Ψ(θ) denotes a wave function, E denotes an energy, and θ denotes a parameter.

The Hamiltonian H is an operator that is determined on the basis of the structure of the analysis target. The Hamiltonian H is decomposed into a linear combination of a plurality of component Hamiltonians (component Hamiltonians H₁, H₂, H₃, . . . ). Each component Hamiltonian may be represented as the matrix product of basic Pauli matrices such as X, Y, and Z matrices. The component energy Eᵢ(θ) corresponding to a certain component Hamiltonian Hᵢ is obtained in a single computation of the quantum circuit 130. The linear combination of the plurality of component energies is the energy E(θ) corresponding to the wave function Ψ(θ).

The quantum circuit 130 defines a quantum computation on a plurality of qubits. The quantum circuit 130 includes an ansatz circuit 131 and a Hamiltonian circuit 132. At the beginning of the quantum circuit 130, the plurality of qubits are each initialized to a state like |0>. The wave function Ψ₀ in the initial state is represented by the initial states of the plurality of qubits. The ansatz circuit 131 transforms the initial quantum state into a quantum state representing a trial wave function Ψ(θ). At least one of the quantum gates included in the ansatz circuit 131 is a parameterized quantum gate that performs a quantum operation based on the value of the parameter θ. Therefore, the quantum circuit 130 is a parameterized quantum circuit that performs a quantum computation based on the value of the parameter θ. By inputting a value into the parameter θ, a quantum circuit corresponding to the wave function Ψ(θ) is generated from the quantum circuit 130.

The Hamiltonian circuit 132 performs a transformation on the plurality of qubits, which is equivalent to the action of the component Hamiltonian Eᵢ(θ) on the wave function Ψ(θ). The Hamiltonian circuit 132 transforms the quantum state representing the wave function Ψ(θ) into a quantum state representing HᵢΨ(θ). The quantum circuit 130 may include a plurality of Hamiltonian circuits corresponding to a plurality of component Hamiltonians. Furthermore, the Hamiltonian circuit 132 may be changed depending on the component Hamiltonian Hᵢ being used. At the end of the quantum circuit 130, the states of the plurality of qubits are measured, and the component energy Eᵢ(θ) is computed from these measured states of the plurality of qubits.

The quantum circuit 130 is executed on a quantum computer or on a quantum circuit simulator running on a classical computer. In the case of the quantum computer, the measured states of the qubits are probabilistically obtained. Therefore, the quantum computer repeatedly measures the component energy Eᵢ(θ) for the same value of the parameter θ and the same component Hamiltonian Hᵢ, and obtains an expected value of the component energy Eᵢ(θ) by averaging the measurement results. The quantum circuit simulator, on the other hand, does not need to repeatedly measure the component energy Eᵢ(θ).

The optimization unit 133 executes an optimization algorithm to optimize the value of the parameter θ using the quantum circuit 130. The optimization unit 133 is implemented on the classical computer. The optimization unit 133 inputs an initial value into the parameter θ of the ansatz circuit 131, and obtains a plurality of component energies corresponding to the plurality of component Hamiltonians. The optimization unit 133 computes the linear combination of the obtained component energies to thereby obtain the energy E(θ).

The optimization unit 133 selects a value for the parameter θ for the next trial so that the energy E(θ) becomes smaller than its current value. For selecting the value for the parameter θ, for example, sequential least squares quadratic programming (SLSQP) may be used. For example, the optimization unit 133 adds a fixed small amount δ to the current value of the parameter θ and substitutes the resulting value for the parameter θ of the ansatz circuit 131. The optimization unit 133 computes the energy E(θ+δ), resulting from the addition of δ, on the basis of the output of the quantum circuit 130.

The optimization unit 133 computes the gradient of the energy E(θ) on the basis of the difference between E(θ) and E(θ+δ). For example, the gradient is computed as (E(θ+δ)−E(θ))/δ. The optimization unit 133 then selects a value for the parameter θ for the next trial on the basis of the computed gradient. For example, the optimization unit 133 subtracts a value obtained by multiplying the gradient by a certain coefficient from the current value of the parameter θ. Then, the optimization unit 133 substitutes the selected value for the parameter θ of the ansatz circuit 131.

The ansatz circuit 131 may have a plurality of parameters. For example, the ansatz circuit 131 may include a plurality of quantum gates that depend on different parameters. In this case, the optimization unit 133 computes a gradient for each individual parameter by changing the value of the parameter by δ. The optimization unit 133 then selects a combination of values for the plurality of parameters on the basis of the computed gradients.

The optimization unit 133 iteratively performs the above process until a stop condition is satisfied. The stop condition may be that the number of iterations, which is the number of times a value is selected for the parameter θ, exceeds a threshold, or that the magnitude of the computed gradient becomes less than a threshold. The optimization unit 133 outputs the lowest value of the energy E(θ) computed so far as the ground-state energy and outputs the value of the parameter θ corresponding to the ground-state energy as the optimal value of the parameter θ.

In the second embodiment, the information processing apparatus 100 executes software corresponding to the optimization unit 133. By executing the software for the quantum circuit simulation, the information processing apparatus 100 computes the component energy Eᵢ(θ) from the quantum circuit 130.

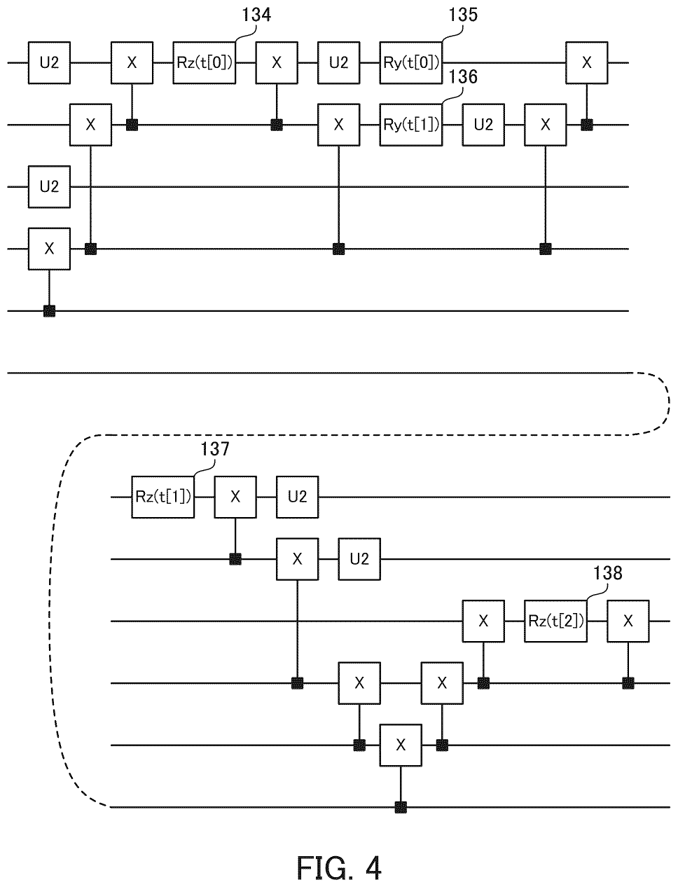

FIG. 4 illustrates an example of an ansatz circuit with parameters.

This quantum circuit is included in, for example, the above-described ansatz circuit 131. In FIG. 4, X is a controlled-NOT gate. U2 is a unitary rotation gate that rotates by π/2 around the Y-axis. Ry(φ) is a rotation gate that rotates by φ around the Y-axis. Rz(φ) is a rotation gate that rotates by φ around the Z-axis.

This quantum circuit includes quantum gates 134 to 138. The quantum gates 134 to 138 are parameterized quantum gates. The quantum gates 134 and 135 depend on a parameter t[0] indicating a rotation angle. The quantum gates 136 and 137 depend on a parameter t[1] indicating a rotation angle. The quantum gate 138 depends on a parameter t[2] indicating a rotation angle. Changing the values of these three parameters changes the quantum operations of the corresponding quantum gates 134 to 138, which in turn changes the quantum state output by the ansatz circuit 131. Note that the quantum operations of the other quantum gates are not affected by these three parameters.

The quantum circuit simulation will now be described. In the second embodiment, the information processing apparatus 100 performs quantum circuit simulation with the tensor network method. In general, a classical computer is able to represent an n-qubit quantum state as a 2ⁿ-dimensional complex vector, and a quantum operation on this quantum state as a (2ⁿ×2ⁿ)-dimensional complex matrix. However, a simulation using such large-scale vectors and matrices may involve a large amount of data and need a large computation amount, and is therefore impractical.

The tensor network method represents quantum states and quantum circuits using tensor networks. A tensor network represents a large tensor as the product of smaller tensors. In the second embodiment, the information processing apparatus 100 uses matrix product states (MPSs), which are a type of tensor network.

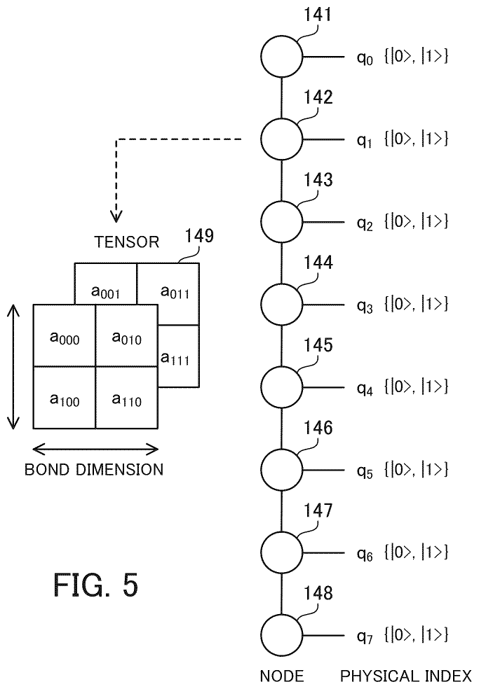

FIG. 5 illustrates an example of the structure of a matrix product state.

An MPS includes a plurality of nodes corresponding to a plurality of qubits, and these nodes are connected in series. As an example, FIG. 5 illustrates an MPS in which the number of qubits n is eight. This MPS includes nodes 141 to 148. The nodes 141 to 148 correspond to different qubits. Each of the nodes 141 to 148 has an open leg called a physical index. A physical index represents the state of a qubit, |0> or |1>, and is a leg of dimension 2.

In addition, adjacent nodes among the nodes 141 to 148 share a leg therebetween. Each leg between the adjacent nodes is given a dimension called a bond dimension. Different legs may have different bond dimensions. The top node 141 and the bottom node 148 each have two legs. The intermediate nodes 142 to 147 each have three legs. Each of the nodes 141 to 148 has a tensor whose order equals the number of legs. That is, the top node 141 and the bottom node 148 each have a second-order tensor, whereas the intermediate nodes 142 to 147 each have a third-order tensor.

For example, the node 142 has a third-order tensor 149. The first-order size (the number of rows or height) of the tensor 149 corresponds to the bond dimension of the upper leg. The second-order size (the number of columns or width) of the tensor 149 corresponds to the bond dimension of the lower leg. The third-order size (depth) of the tensor 149 is 2, corresponding to the physical index for |0> and |1>. Note that the node 141 may be considered as having a third-order tensor with the first-order size of 1 and that the node 148 may be considered as having a third-order tensor with the second-order size of 1.

The information processing apparatus 100 generates an MPS representing an initialized quantum state and connects the MPS to the beginning of a quantum circuit. Then, the information processing apparatus 100 performs “contraction,” which combines one quantum gate with the MPS, sequentially in the direction from the beginning to the end of the quantum circuit. The quantum operation of each quantum gate is also represented as a tensor. An m-input, m-output quantum gate, which acts on m qubits, is considered as a node with a tensor of order 2m. A contraction is the computation of the product of two tensors. An MPS resulting from the contraction of quantum gates represents a quantum state obtained as a result of executing the quantum gates.

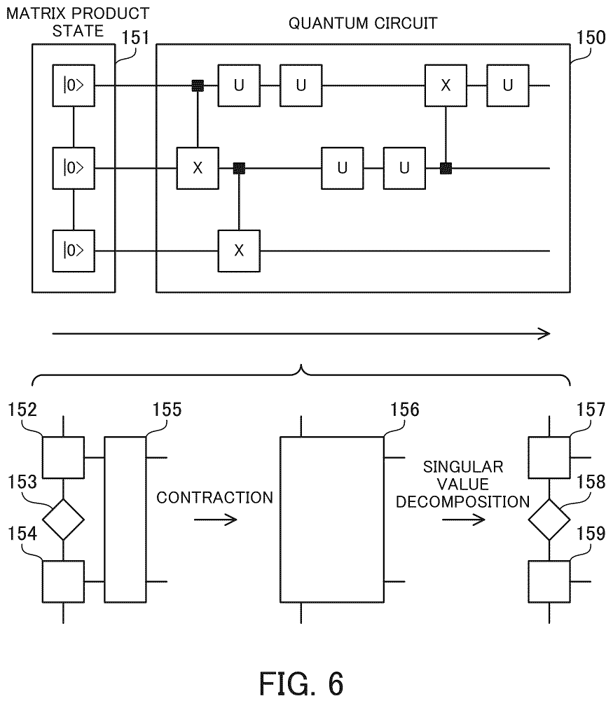

FIG. 6 illustrates an example of computing a quantum circuit using an MPS.

The information processing apparatus 100 connects an MPS 151 to the beginning of a quantum circuit 150. The MPS 151 corresponds to a vector representing a quantum state where each qubit is initialized to |0>. In the example of FIG. 6, the number of qubits n is three. The information processing apparatus 100 sequentially combines each quantum gate with the MPS 151 in the direction from the beginning to the end of the quantum circuit 150.

Here, to streamline the MPS computation, an auxiliary node is inserted between main nodes with physical indices in the MPS 151. Since the auxiliary node does not have any physical index but is connected to the two main nodes, the auxiliary node has a second-order tensor. Such an MPS structure is sometimes called a canonical form. For example, nodes 152 and 154 each have a physical index, and a node 153 is connected to the nodes 152 and 154. The node 152 has a third-order tensor, the node 153 has a second-order tensor, and the node 154 has a third-order tensor.

In the case where a quantum gate to be contracted is a single-input quantum gate, the information processing apparatus 100 computes the product of the tensor of a node in the MPS 151 connected to the quantum gate and the tensor of the quantum gate. In the contraction, the information processing apparatus 100 performs element-wise multiplication and summation between the two tensors such as to eliminate the order corresponding to the shared leg from both of the two tensors. In the case where the single-input quantum gate is contracted, the resulting node has one physical index, and the computed product is a third-order tensor. Thus, the MPS structure is maintained.

On the other hand, in the case where a quantum gate to be contracted is a multi-input quantum gate, for example, the information processing apparatus 100 combines the tensors of the plurality of nodes connected to the quantum gate such as to match the size of the resulting tensor to the quantum gate. Then, the information processing apparatus 100 computes the product of the tensor at the MPS 151 side and the tensor of the quantum gate. In the case where the multi-input quantum gate is contracted, the resulting node has a plurality of physical indices, and the computed product is a fourth-order or higher-order tensor. That is, the MPS structure is disrupted by the contraction.

To address this, the information processing apparatus 100 restores the contracted tensor network back to the MPS structure using singular value decomposition (SVD). In a single SVD operation, a tensor is decomposed into the product of three tensors. As a result, the node resulting from the contraction is split into the same number of nodes as before the contraction, so as to recover the MPS structure in which each node has at most one physical index.

For example, a node 155 is connected to the nodes 152 and 154. The node 155 represents a two-input quantum gate. The information processing apparatus 100 contracts the nodes 152 to 155 into a node 156. The node 156 has four legs including two physical indices and has a fourth-order tensor as a result of combining the tensors of the nodes 152 to 155.

The information processing apparatus 100 performs the SVD on the node 156 to transform the node 156 into nodes 157 to 159. That is, through the SVD, the tensor of the node 156 is decomposed into the product of three tensors. The nodes 157 to 159 correspond to these three tensors. The nodes 157 and 159 correspond to the nodes 152 and 154 before the contraction, each with three legs including one physical index. The nodes 157 and 159 each have a third-order tensor. The node 158 corresponds to the node 153 before the contraction and is connected to the nodes 157 and 159. The node 158 has a second-order tensor.

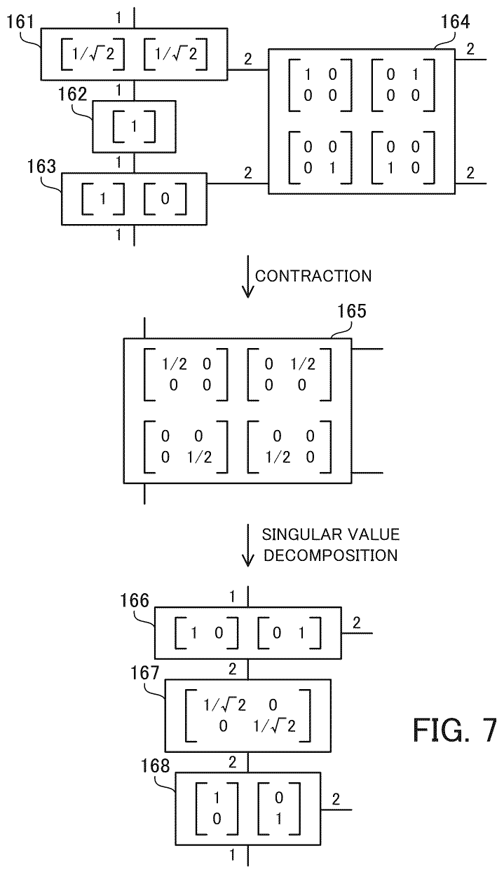

FIG. 7 illustrates a first example of contraction and singular value decomposition.

Nodes 161 and 163 are main nodes. A node 162 is an auxiliary node connected to the nodes 161 and 163. The node 161 has three legs whose dimensions are 1, 1, and 2. Therefore, the node 161 has a 1×1×2 tensor. The node 162 has two legs of dimensions 1 and 1. Therefore, the node 162 has a 1×1 tensor. The node 163 has three legs of dimensions 1, 1, and 2. Therefore, the node 163 has a 1×1×2 tensor.

A node 164 representing a two-input quantum gate is connected to the nodes 161 and 163. The node 164 has four legs of dimensions 2, 2, 2, and 2. Therefore, the node 164 has a 2×2×2×2 tensor. In FIG. 7, a first-order tensor is represented by a single matrix, and a second-order tensor is also represented by a single matrix. In addition, in FIG. 7, a third-order tensor is represented by placing a plurality of matrices side by side horizontally. Furthermore, a fourth-order tensor is represented by stacking sets of horizontally arranged matrices vertically.

The information processing apparatus 100 contracts the nodes 161 to 164 into a node 165. The node 165 has a 2×2×2×2 tensor. Therefore, the information processing apparatus 100 performs the SVD on the node 165 to split the node 165 into nodes 166 to 168.

The nodes 166 and 168 are main nodes. The node 167 is an auxiliary node connected to the nodes 166 and 168. The node 166 has three legs of dimensions 1, 2, and 2. Therefore, the node 166 has a 1×2×2 tensor. The node 167 has two legs of dimensions 2 and 2. Therefore, the node 167 has a 2×2 tensor. The node 168 has three legs of dimensions 2, 1, and 2. Therefore, the node 168 has a 2×1×2 tensor. As described above, the bond dimensions of the legs between the nodes may vary through the contraction.

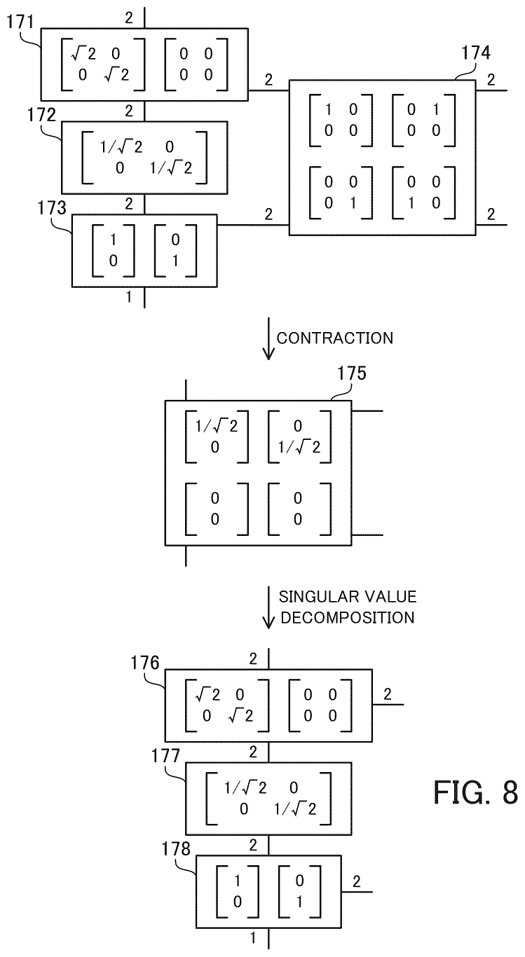

FIG. 8 illustrates a second example of contraction and singular value decomposition.

Nodes 171 and 173 are main nodes. A node 172 is an auxiliary node connected to the nodes 171 and 173. The node 171 has three legs of dimensions 2, 2, and 2. Therefore, the node 171 has a 2×2×2 tensor. The node 172 has two legs of dimensions 2 and 2. Therefore, the node 172 has a 2×2 tensor. The node 173 has three legs of dimensions 2, 1, and 2. Thus, the node 173 has a 2×1×2 tensor.

A node 174 representing a two-input quantum gate is connected to the nodes 171 and 173. The node 174 has four legs of dimensions 2, 2, 2, and 2. Therefore, the node 174 has a 2×2×2×2 tensor. The information processing apparatus 100 contracts the nodes 171 to 174 into a node 175. The node 175 has a 2×2×2×2 tensor. The information processing apparatus 100 performs the SVD on the node 175 to split the node 175 into nodes 176 to 178.

The nodes 176 and 178 are main nodes. The node 177 is an auxiliary node connected to the nodes 176 and 178. The node 176 has three legs of dimensions 2, 2, and 2. Therefore, the node 176 has a 2×2×2 tensor. The node 177 has two legs of dimensions 2 and 2. Therefore, the node 177 has a 2×2 tensor. The node 178 has three legs of dimensions 2, 1, and 2. Therefore, the node 178 has a 2×1×2 tensor.

After contracting all quantum gates included in a quantum circuit, one final MPS remains. This MPS represents the quantum state at the end of the quantum circuit. The information processing apparatus 100 reads the tensor from the MPS to obtain the measured states of the plurality of qubits. In the computation of such a quantum circuit, the information processing apparatus 100 typically performs the contractions of the quantum gates in the forward direction from the beginning to the end of the quantum circuit.

Note that the result of computing the quantum circuit does not depend on the order of quantum gate contractions. Therefore, the information processing apparatus 100 may contract quantum gates located in the middle of the quantum circuit first, or may perform the contractions in the backward direction from the end to the beginning of the quantum circuit.

When the quantum gates are contracted in an order other than the one based on the forward direction, combined quantum gates may form a matrix product operator (MPO). Like an MPS, the MPO is such that a plurality of nodes each having a tensor are connected in series. The MPS represents a quantum state, whereas the MPO represents a quantum operation. In the MPO, each main node has physical indices not only at the end side of the quantum circuit but also at the beginning side of the quantum circuit. Therefore, each main node of the MPO has a fourth-order tensor.

As mentioned earlier, the information processing apparatus 100 selects a value for a parameter in a quantum circuit and computes the computation result of the quantum circuit through the quantum circuit simulation. To select a value for the parameter for the next trial, the information processing apparatus 100 also computes the computation result of a quantum circuit generated by slightly changing the current value of the parameter by a small amount δ. In the case where a plurality of parameters exist, the information processing apparatus 100 changes the value of each individual parameter by d. Therefore, each time selecting a set of values for the parameters, the information processing apparatus 100 generates as many quantum circuits as the number of parameters plus one, and computes their computation results.

Contracting the entire quantum circuit using a classical computer needs a high computation amount and a high computational load. However, a quantum circuit generated from a reference quantum circuit by the addition of δ differs from the reference quantum circuit by only a few quantum gates, with most quantum gates remaining the same. Therefore, the information processing apparatus 100 in the second embodiment reuses intermediate contraction results of the reference quantum circuit in order to reduce the computation amount of the quantum circuit simulation.

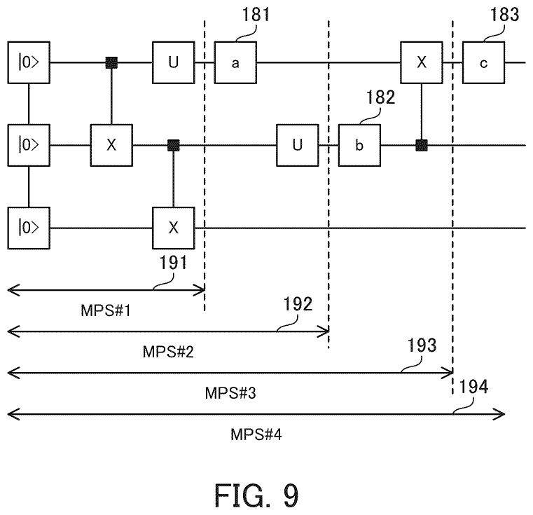

FIG. 9 illustrates an example of saving reusable matrix product states.

The information processing apparatus 100 substitutes selected values for parameters to generate a reference quantum circuit, which is before the addition of δ. The information processing apparatus 100 connects an MPS to the beginning of the reference quantum circuit and performs contraction on the quantum gates in the forward direction. Each time a parameterized quantum gate is detected, the information processing apparatus 100 saves the MPS obtained just before the detection.

For example, the quantum circuit includes quantum gates 181 to 183 that are parameterized quantum gates. First, the information processing apparatus 100 performs contraction up to just before the quantum gate 181. The information processing apparatus 100 then saves an MPS #1 at this time point as the contraction result of a section 191 ranging from the beginning to just before the quantum gate 181.

Subsequently, the information processing apparatus 100 continues the contraction up to just before the quantum gate 182. The information processing apparatus 100 then saves an MPS #2 at this time point as the contraction result of a section 192 ranging from the beginning to just before the quantum gate 182. Subsequently, the information processing apparatus 100 continues the contraction up to just before the quantum gate 183. The information processing apparatus 100 then saves an MPS #3 at this time point as the contraction result of a section 193 ranging from the beginning to just before the quantum gate 183.

Lastly, the information processing apparatus 100 continues the contraction up to the end of the quantum circuit. As a result, the information processing apparatus 100 obtains an MPS #4 representing the computation result of a section 194 ranging from the beginning to the end of the quantum circuit. In the manner described above, the information processing apparatus 100 saves one or more possibly reusable contraction results of quantum gates at the beginning side of the reference quantum circuit, during the single forward computation of the reference quantum circuit.

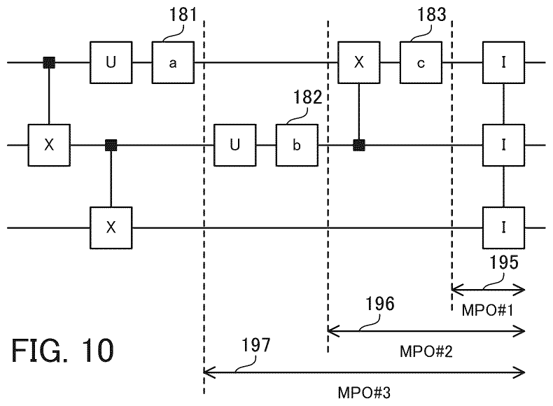

FIG. 10 illustrates an example of saving reusable matrix product operators.

In order to increase the number of reusable contraction results, the information processing apparatus 100 computes the reference quantum circuit in the backward direction, in addition to the forward computation. First, the information processing apparatus 100 generates an MPO in which each main node represents an identity gate I, and connects the MPO to the end of the quantum circuit. The identity gate I is a quantum gate that leaves the state of a qubit unchanged. The information processing apparatus 100 performs contraction on the quantum gates in the backward direction, and each time detecting a parameterized quantum gate, the information processing apparatus 100 saves an MPO at this time point (at the position just after the parameterized quantum gate).

For example, the information processing apparatus 100 performs the backward contraction to the position just after the quantum gate 183. The information processing apparatus 100 then saves an MPO #1 at this time point as the contraction result of a section 195 ranging from the end back to just after the quantum gate 183. Subsequently, the information processing apparatus 100 continues the backward contraction to just after the quantum gate 182. The information processing apparatus 100 then saves an MPO #2 at this time point as the contraction result of a section 196 ranging from the end back to just after the quantum gate 182. Subsequently, the information processing apparatus 100 continues the backward contraction to just after the quantum gate 181. The information processing apparatus 100 then saves an MPO #3 at this time point as the contraction result of a section 197 ranging from the end back to just after the quantum gate 181.

In the manner described above, the information processing apparatus 100 saves one or more possibly reusable contraction results of quantum gates at the end side of the reference quantum circuit, during the single backward computation of the reference quantum circuit. That is, the information processing apparatus 100 computes the reference quantum circuit twice: once in the forward direction and once in the backward direction. In this connection, in the backward computation, the information processing apparatus 100 may connect an MPS to the beginning of the quantum circuit and obtain the MPS #4 for the section 194. Instead of obtaining the MPS #4 in the forward computation, the information processing apparatus 100 may obtain the MPS #4 in the backward computation.

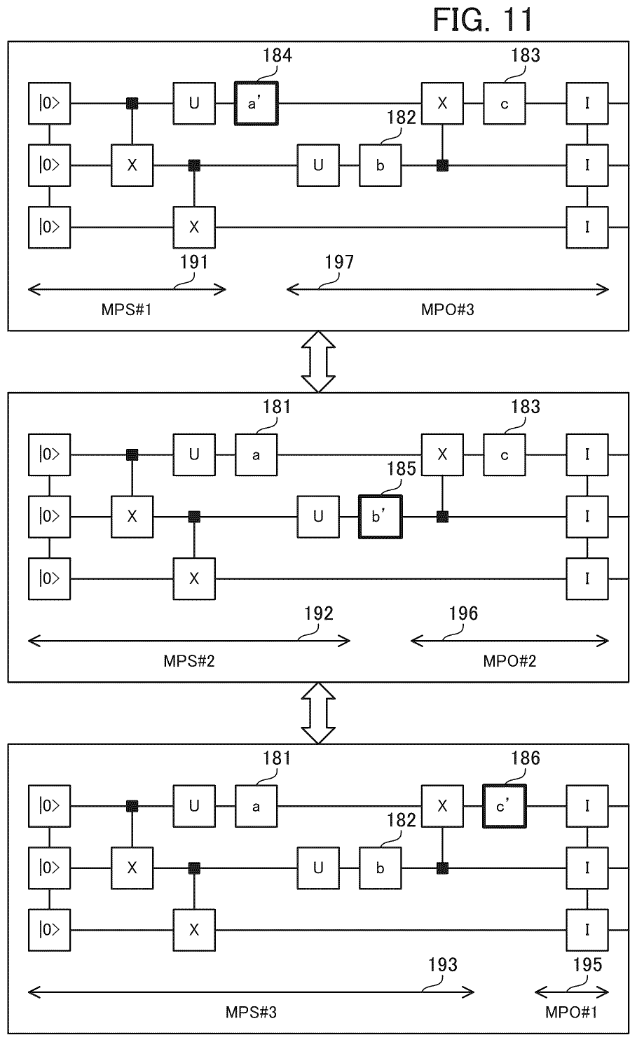

FIG. 11 illustrates an example of reusing matrix product states and matrix product operators.

The information processing apparatus 100 generates three modified quantum circuits, each by adding 8 to the value of a different one of three parameters that define the quantum gates 181 to 183. The first quantum circuit includes a quantum gate 184 that replaces the quantum gate 181. The second quantum circuit includes a quantum gate 185 that replaces the quantum gate 182. The third quantum circuit includes a quantum gate 186 that replaces the quantum gate 183.

With regard to the first quantum circuit, the information processing apparatus 100 reads the MPS of the longest possible reusable section located before the quantum gate 184 from the saved set of MPSs. Here, the information processing apparatus 100 reads the MPS #1 of the section 191. In addition, the information processing apparatus 100 reads the MPO of the longest possible reusable section located after the quantum gate 184 from the saved set of MPOs. Here, the information processing apparatus 100 reads the MPO #3 of the section 197.

The information processing apparatus 100 computes the computation result of the first quantum circuit reusing the MPS #1 and MPO #3. For example, the information processing apparatus 100 contracts a tensor representing the quantum gate 184 with the MPS #1, and then further contracts the MPO #3 with the resulting MPS. As a result, an MPS representing the final quantum state is computed. Note that the information processing apparatus 100 may perform backward contraction instead of the forward contraction.

Similarly, with regard to the second quantum circuit, the information processing apparatus 100 reads the MPS of the longest possible reusable section located before the quantum gate 185 from the saved set of MPSs. Here, the information processing apparatus 100 reads the MPS #2 of the section 192. In addition, the information processing apparatus 100 reads the MPO of the longest possible reusable section located after the quantum gate 185 from the saved set of MPOs. Here, the information processing apparatus 100 reads the MPO #2 of the section 196.

The information processing apparatus 100 computes the computation result of the second quantum circuit reusing the MPS #2 and MPO #2. For example, the information processing apparatus 100 contracts a tensor representing the quantum gate 185 with the MPS #2, and then further contracts the MPO #2 with the resulting MPS.

With regard to the third quantum circuit, the information processing apparatus 100 reads the MPS of the longest possible reusable section located before the quantum gate 186 from the saved set of MPSs. Here, the information processing apparatus 100 reads the MPS #3 of the section 193. In addition, the information processing apparatus 100 reads the MPO of the longest possible reusable section located after the quantum gate 186 from the saved set of MPOs. Here, the information processing apparatus 100 reads the MPO #1 of the section 195.

The information processing apparatus 100 computes the computation result of the third quantum circuit reusing the MPS #3 and MPO #1. For example, the information processing apparatus 100 contracts a tensor representing the quantum gate 186 with the MPS #3, and then further contracts the MPO #1 with the resulting MPS.

In the second embodiment, the information processing apparatus 100 reuses both a result of the forward contraction and a result of the backward contraction. Alternatively, the information processing apparatus 100 may reuse only one of them. Furthermore, the information processing apparatus 100 in the second embodiment performs the quantum circuit simulation using MPSs, which are a type of tensor network. The above-described method of reusing contraction results is applicable to other quantum circuit simulation methods as well.

For example, the information processing apparatus 100 may perform a quantum circuit simulation with the state vector method. In this case, in the forward computation of a reference quantum circuit, the information processing apparatus 100 may save a state vector obtained at a position just before a parameterized quantum gate. In addition, in the backward computation of the reference quantum circuit, the information processing apparatus 100 may save a matrix obtained at a position just after a parameterized quantum gate. The information processing apparatus 100 may reuse at least one of the saved state vector and the saved matrix for a quantum circuit generated by the addition of 8, to omit the matrix computation for a common part.

Furthermore, for example, the information processing apparatus 100 may perform a quantum circuit simulation with a general tensor network method other than MPS. The general tensor network method allows the situations in which a contraction result of quantum gates is not in the MPS form or MPO form and the order of a tensor varies before and after the contraction.

In that case, the information processing apparatus 100 may save a tensor network obtained at a position just before a parameterized quantum gate in the forward computation of a reference quantum circuit. In addition, the information processing apparatus 100 may save a tensor network obtained at a position just after a parameterized quantum gate in the backward computation of the reference quantum circuit. The information processing apparatus 100 may reuse at least one of the saved tensor network obtained in the forward computation and the saved tensor network obtained in the backward computation, for a quantum circuit generated by the addition of õ, to omit the contraction for a common part.

Moreover, while the information processing apparatus 100 reuses the MPS of a section including the beginning of the quantum circuit and the MPO of a section including the end of the quantum circuit, the information processing apparatus 100 may also reuse the MPO of an intermediate section including neither the beginning nor the end of the quantum circuit. In the second embodiment, the information processing apparatus 100 reuses contraction results obtained from the reference quantum circuit for a quantum circuit used in gradient computation. Furthermore, the information processing apparatus 100 may also reuse the contraction results of sections that do not include any parameterized quantum gate for the next and subsequent reference quantum circuits with changed values of parameters.

The following describes the functions and processing procedures of the information processing apparatus 100.

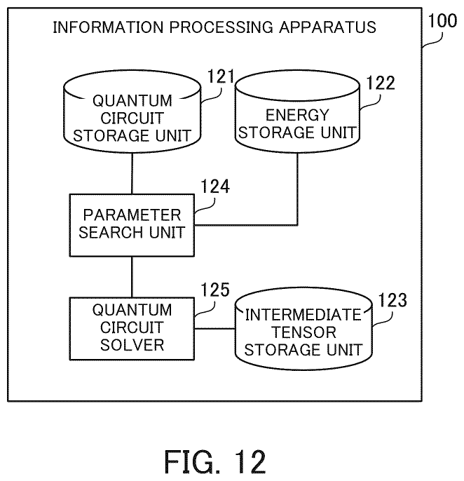

FIG. 12 illustrates an example of the functions of the information processing apparatus according to the second embodiment.

The information processing apparatus 100 includes a quantum circuit storage unit 121, an energy storage unit 122, an intermediate tensor storage unit 123, a parameter search unit 124, and a quantum circuit solver 125. The quantum circuit storage unit 121, energy storage unit 122, and intermediate tensor storage unit 123 are implemented by using, for example, the RAM 102 or HDD 103. The parameter search unit 124 and quantum circuit solver 125 are implemented by using, for example, the CPU 101 and programs.

The quantum circuit storage unit 121 stores a parameterized quantum circuit. The parameterized quantum circuit is created on the basis of the structure of an analysis target such as a molecular structure. The parameterized quantum circuit may be created by a user or may be created from structural information by software. The information processing apparatus 100 may accept the parameterized quantum circuit input by the user, or may receive the parameterized quantum circuit from another information processing apparatus.

The energy storage unit 122 stores the tried values of parameters in association with the computed energies. The intermediate tensor storage unit 123 stores contraction results that are reusable in quantum circuit simulation. These contraction results include MPSs and MPOs.

The parameter search unit 124 searches for values of the parameters that yield the ground-state energy, on the basis of the parameterized quantum circuit stored in the quantum circuit storage unit 121. The parameter search unit 124 inputs values into the parameters to generate a quantum circuit and causes the quantum circuit solver 125 to compute the computation result of the quantum circuit. The parameter search unit 124 stores the tried values of the parameters and the computed energy in the energy storage unit 122. In addition, the parameter search unit 124 computes the gradient of the energy with respect to the value of each parameter, and selects a set of values for the parameters for the next trial on the basis of the gradients. The parameter search unit 124 iterates the selection of values for the parameters and energy computation until a stop condition is satisfied.

The quantum circuit solver 125 receives the quantum circuit from the parameter search unit 124 and computes the computation result of the quantum circuit through quantum circuit simulation. Among the quantum gates of the quantum circuit, the quantum gates with values input into their parameters are specified by the parameter search unit 124. During the process of computing the computation result of the received quantum circuit, the quantum circuit solver 125 saves reusable contraction results in the intermediate tensor storage unit 123. After that, the quantum circuit solver 125 computes the computation result of a quantum circuit generated by the addition of δ. At this time, the quantum circuit solver 125 reuses contraction results saved in the intermediate tensor storage unit 123.

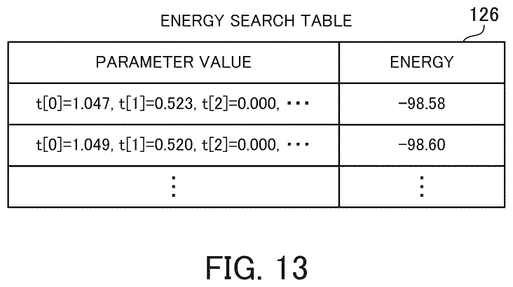

FIG. 13 illustrates an example of an energy search table.

The energy storage unit 122 stores an energy search table 126. The energy search table 126 contains a plurality of records that each associate parameter values with an energy. Each record contains a set of values input into a plurality of parameters including parameters t[0], t[1], t[2], and so on. The energy indicates the total energy of an analysis target and is a linear combination of a plurality of component energies computed from a quantum circuit.

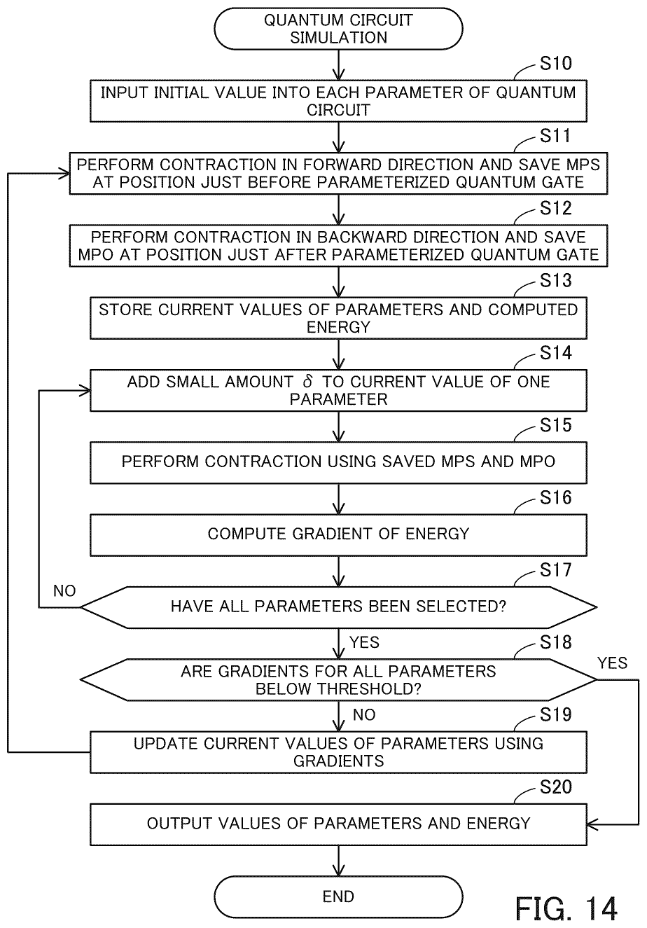

FIG. 14 is a flowchart of an example procedure for quantum circuit simulation.

(S10) The parameter search unit 124 inputs initial values into the parameters of a parameterized quantum circuit to generate an executable quantum circuit. Each initial value may be a fixed value, such as 0 or 1, or a randomly selected value.

(S11) The quantum circuit solver 125 connects an MPS representing an initial quantum state to the beginning of the quantum circuit and then performs contraction on the quantum gates in the forward direction. During this contraction, the quantum circuit solver 125 saves an MPS obtained at a position just before a parameterized quantum gate. The quantum circuit solver 125 performs the contraction up to the end of the quantum circuit and outputs the computation result of the quantum circuit.

(S12) The quantum circuit solver 125 connects an MPO representing identity gates to the end of the quantum circuit and performs contraction on the quantum gates in the backward direction. During this contraction, the quantum circuit solver 125 saves an MPO obtained at a position just after a parameterized quantum gate.

(S13) The parameter search unit 124 computes an energy corresponding to the current values of the parameters. For example, the parameter search unit 124 combines a plurality of computation results corresponding to a plurality of component Hamiltonians to compute the total energy. The parameter search unit 124 stores the current values of the parameters and the computed energy in the energy search table 126.

(S14) The parameter search unit 124 selects one parameter. The parameter search unit 124 adds a small amount δ to the current value of the selected parameter. For example, the amount δ is a predetermined positive value. The amount δ may vary with the parameter. By doing so, a quantum circuit different from the one used at steps S11 and S12 is generated. Note that the values of the other parameters than the selected one remain at their current values, which are before the addition of δ.

(S15) The quantum circuit solver 125 reads an MPS and MPO reusable for the quantum circuit generated at step S14, from the saved MPSs and MPOs. The quantum circuit solver 125 performs the rest of the contraction using the read MPS and MPO to thereby compute the computation result of the quantum circuit.

(S16) The parameter search unit 124 computes an energy corresponding to the value of the parameter after the addition of δ, on the basis of the computation result obtained at step S15. The parameter search unit 124 compares, for the parameter selected at step S14, the computed energy with the energy obtained at step S13 and computes the gradient of the energy with respect to the value of the parameter.

(S17) The parameter search unit 124 determines whether all parameters have been selected at step S14. If all parameters have been selected, the process proceeds to step S18. If there is any unselected parameter, the process proceeds back to step S14.

(S18) The parameter search unit 124 compares the gradient obtained at step S16 with a threshold for each parameter. The parameter search unit 124 determines whether the gradients for all parameters are below the threshold. If the gradients for all parameters are below the threshold, the process proceeds to step S20. If there is any parameter for which the gradient is greater than or equal to the threshold, the process proceeds to step S19.

(S19) The parameter search unit 124 updates the current values of the parameters using the gradients. For example, the parameter search unit 124 subtracts, for each parameter, the value obtained by multiplying the gradient by a coefficient from the current value of the parameter. Then, the process proceeds back to step S11.

(S20) The parameter search unit 124 outputs information indicating the values of the parameters and the energy. The parameter search unit 124 may output only the optimal values of the parameters and the lowest energy, or may output a plurality of tried sets of values of the parameters and their corresponding energies. The parameter search unit 124 may store the information in a non-volatile storage device, display it on the display device 111, or transmit it to another information processing apparatus.

As described above, the information processing apparatus 100 in the second embodiment is able to execute the VQE. By doing so, the information processing apparatus 100 is able to accurately compute the ground-state energy and electronic structure of a molecule, so as to obtain useful information about the molecule. Moreover, the information processing apparatus 100 computes the computation results of quantum circuits through quantum circuit simulation. As a result, even if a practical quantum computer is not available, the information processing apparatus 100 is able to execute the VQE. In addition, a user is able to develop quantum algorithms and application software suitable for quantum computers in advance.

Furthermore, the information processing apparatus 100 performs the quantum circuit simulation with the tensor network method using MPS. By doing so, the information processing apparatus 100 is able to reduce the computing resources used and the computation time taken, which achieves efficient quantum circuit simulation.

Furthermore, when computing the computation result of a reference quantum circuit, the information processing apparatus 100 saves the MPS of a section ranging from the beginning to just before a parameterized quantum gate. In addition, the information processing apparatus 100 computes the reference quantum circuit in the backward direction and saves the MPO of a section ranging from the end back to just after a parameterized quantum gate. Then, reusing the saved MPS and MPO, the information processing apparatus 100 computes the computation result of a quantum circuit generated with a slightly changed value of a parameter for gradient computation. With this approach, the information processing apparatus 100 is able to omit the contraction for many sections within the quantum circuit used for the gradient computation. As a result, the computation amount of the quantum circuit simulation is reduced, and the computation time is also reduced.

In one aspect, the computation time of a quantum circuit is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a process comprising:
obtaining quantum circuit data defining a quantum circuit that varies with a value of a parameter;
generating, using first tensor data for a common part of a first quantum circuit and a second quantum circuit, second tensor data,
the first tensor data representing a quantum operation performed by one or more quantum gates included in the common part,
the second tensor data representing a computation result of the common part,
the first quantum circuit being generated with a first value input into the parameter,
the second quantum circuit being generated with a second value input into the parameter,
the common part being where types and sequence of the one or more quantum gates are common; and
computing a computation result of the first quantum circuit and a computation result of the second quantum circuit using the second tensor data.

2. The non-transitory computer-readable storage medium according to claim 1, wherein
the second tensor data is generated during a computation process of transforming tensor data in a forward direction from a beginning of the first quantum circuit to an end of the first quantum circuit or in a backward direction from the end to the beginning, and
the computation result of the first quantum circuit is computed as a result of completing the computation process.

3. The non-transitory computer-readable storage medium according to claim 1, wherein
the quantum circuit data includes a variable quantum gate that performs a different quantum operation depending on the value of the parameter, and
the common part is a section located before the variable quantum gate in the first quantum circuit or a section located after the variable quantum gate in the first quantum circuit.

4. The non-transitory computer-readable storage medium according to claim 1, wherein
the common part includes a first common part including a beginning of the first quantum circuit and a second common part including an end of the first quantum circuit,
the second tensor data includes third tensor data representing a computation result of the first common part and fourth tensor data representing a computation result of the second common part, and
the computation result of the second quantum circuit is computed using the third tensor data and the fourth tensor data.

5. The non-transitory computer-readable storage medium according to claim 1, wherein the second tensor data represents a tensor network in which a plurality of tensors corresponding to a plurality of qubits are connected in series.

6. The non-transitory computer-readable storage medium according to claim 1, wherein
the computation result of the first quantum circuit indicates a first energy corresponding to the first value, and the computation result of the second quantum circuit indicates a second energy corresponding to the second value, and
the process further includes searching for a value of the parameter that reduces a computed energy, based on the first energy and the second energy.

7. A quantum circuit simulation method comprising:
obtaining, by a processor, quantum circuit data defining a quantum circuit that varies with a value of a parameter;
generating, by the processor, using first tensor data for a common part of a first quantum circuit and a second quantum circuit, second tensor data,
the first tensor data representing a quantum operation performed by one or more quantum gates included in the common part,
the second tensor data representing a computation result of the common part,
the first quantum circuit being generated with a first value input into the parameter,
the second quantum circuit being generated with a second value input into the parameter,
the common part being where types and sequence of the one or more quantum gates are common; and
computing, by the processor, a computation result of the first quantum circuit and a computation result of the second quantum circuit using the second tensor data.

8. An information processing apparatus comprising:
a memory configured to store quantum circuit data defining a quantum circuit that varies with a value of a parameter; and
a processor coupled to the memory and the processor configured to:
generate, using first tensor data for a common part of a first quantum circuit and a second quantum circuit, second tensor data
the first tensor representing a quantum operation performed by one or more quantum gates included in the common part,
the second tensor data representing a computation result of the common part,
the first quantum circuit being generated with a first value input into the parameter,
the second quantum circuit being generated with a second value input into the parameter,
the common part being where types and sequence of the one or more quantum gates are common; and
compute a computation result of the first quantum circuit and a computation result of the second quantum circuit using the second tensor data.
